(19) United States
(12) Patent Application Publication
(10) Pub. No.: US 2005/0175426 A1
(43) Pub. Date: Aug. 11, 2005

(54) Cargo Retention Rail System

(75) Inventors: Douglas J Kroll, Brighton, MI (US); Michael Dykman, Lake Orion, MI (US); David S Bentley, Utica, MI (US)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/708,138

(22) Filed: Feb. 9, 2004

(51) Int. Cl. B60P 1/64

(52) U.S. Cl. 410/77

(57) ABSTRACT

Disclosed is a cargo securing rail system that is molded into a floor panel as an integral part thereof requiring no additional fastening means. The disclosed cargo securing rail system maintains the aesthetics of the vehicle interior it is installed in while providing for the secure retention of cargo items placed within the cargo area.

### BACKGROUND OF INVENTION

1. Field of the Invention

The present invention generally relates to a cargo retention rail system molded into a vehicle floor panel. More particularly the present invention relates to a cargo retention rail system that may be insert-molded into a vehicle floor panel without the need for separate rail fasteners.

2. Description of the Related Art

With the increased popularity of utility vehicles and mini-vans with large rear cargo areas there is a need to provide a safe dependable manner of securing various types of cargo while maintaining the vehicles interior aesthetics. Likewise, it is preferable to maintain the maximum cargo area by having the cargo securing apparatus intruding into the useable space as little as possible. It is also desirable to provide a cargo securing apparatus that minimizes the amount of assembly line time and labor required to install the apparatus.

For example, U.S. Pat. No. 5,544,998 issued Aug. 13, 1996 to Malinowski teaches a selectively retractable cargo compartment load floor that moves on a pair of tracks having a locking mechanism controlled by spring loaded latch.

U.S. Pat. No. 5,715,978 issued Feb. 10, 1998 to Ackeret teaches automotive trunk divider moveable along a track secured to the floor of said trunk. The divider can be manually locked into a desired position.

U.S. Pat. No. 6,109,669 issued Aug. 29, 2000 to Pinkow teaches a foldable closure panel latch having a pawl that engages a track to lock it in place.

U.S. Pat. No. 6,145,910 issued Nov. 14, 2000 to Baldas et al teaches a auxiliary track system that latches to a pre-existing seat mounting fixtures allowing for the seats to be mounted in different locations than the original seat mounting fixtures on said auxiliary track.

U.S. Patent Application Publication Number 2001/0054632 published Dec. 27, 2001 to Larsen et al teaches an apparatus that can be clamped to the floor attachments of a motor vehicle used to secure removable seats. The securing of the apparatus to the floor attachments is accomplished by pincers that lock around the floor attachment bars.

### DISCLOSURE OF THE INVENTION

The present invention provides advantages and alternatives over the prior art by providing an efficient, cost effective cargo securing apparatus which eliminates much of the assembly line installation required in more traditional apparatus.

According to a further aspect of the present invention, provides a cargo securing apparatus that is molded into the floor panel as an integral part thereof. This eliminates the necessity of installing the floor panel and the cargo securing apparatus in separate steps.

According to yet another aspect of the present invention provides for a cargo securing apparatus that reduces the cost, labor, and tooling required to install it in a vehicle.

According to a yet further aspect of the present invention there is provided a cargo retention rail system molded as an integral part of a vehicle floor panel for securing cargo in a vehicle cargo area comprising in cooperative combination: at least one cargo retention rail molded into a vehicle floor panel, said cargo retention rail having a channel with an exposed opening for accepting; a cargo retention locking device; and a cargo retaining device mountable to said cargo retention locking device; thereby allowing for cargo to be securely positioned within a vehicle cargo area.

The present invention thus advantageously provides a cost effective cargo securing apparatus that maintains the vehicle decor aesthetics, reduces costs, and eliminates installation steps in the assembly of vehicles containing said apparatus.

### BRIEF DESCRIPTION OF DRAWINGS

FIG. 1 shows a plan side view section of one embodiment of the present invention.

FIG. 2 shows a plan top view section of the embodiment of the present invention of FIG. 1.

### DETAILED DESCRIPTION

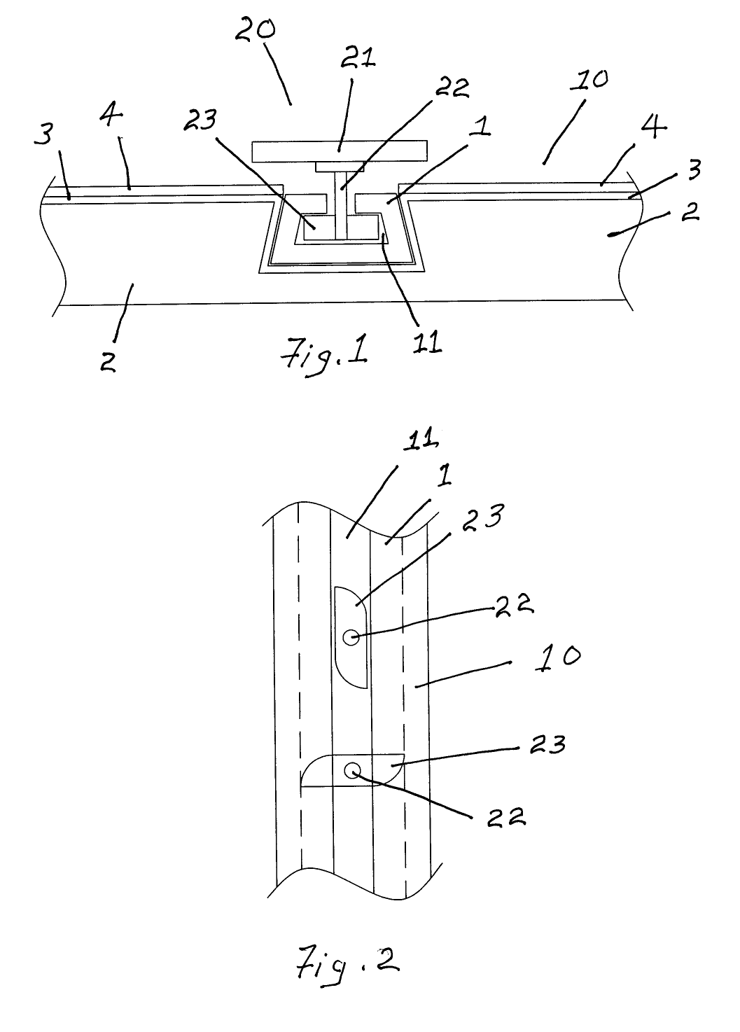

Reference will now be made to the drawings, wherein to the extent possible like reference numerals are utilized to designate like components throughout the various views. Referring to FIG. 1, which presents a preferred embodiment of the present invention showing a cargo securing rail extrusion 1 having a locking channel 11 molded into a floor panel 10 comprising a molded substrate 2, and optional adhesive layer 3, and a cover material 4.

As further shown in FIG. 1 there is a cargo-locking device 20 comprising a manual operating handle 21 connected to one end of a locking device shaft 22 and having on locking device shaft 22 other end a locking arm 23. Said cargo-locking device 20 having the locking arm 23 located within the locking channel 11 of rail extrusion 1 and said manual operating handle located above said floor panel 10 such that it is accessible to one securing or removing cargo.

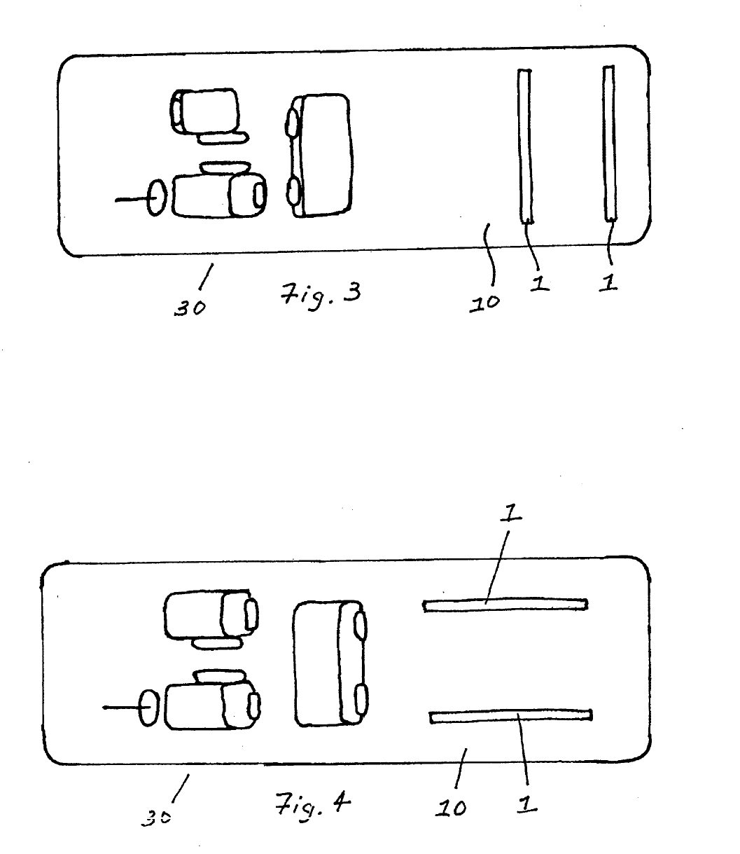

Referring now to FIGS. 2 there is shown a top view of a section of a vehicle floor panel 10 showing a section of the floor panel 10, a section of the rail extrusion 1 having locking channel 11 as well as locking device shaft 22 and locking arm 23 in both a unlocked and an locked position configuration. The handle 21 is omitted for clarity.

The molded substrate 2 may be of any suitable material. The presently preferred materials are high-density polyethylene (HDPE), talc-filled polypropylene, and glass-filled polypropylene. The presently preferred method of molding said substrate 2 is by blow molding. The adhesive layer 3 may be any suitable adhesive well known in the art, presently preferred is hot melt, water-based, solvent-based, and roll-coated applied adhesives. The cover material 4 may be a textile material or a non-textile material selected from those well known in the art. The presently preferred cover material 4 is carpet, textile materials, and non-textile materials.

The rail extrusion 1 may be of any suitable material known in the art. The presently preferred materials are aluminum and polymer, particularly engineered resin polymers.

The cargo-locking device may by manual, or automatic in nature and of any suitable design and material well known in the art. The presently preferred locking device is a manual twist lock mechanism comprising a metal locking device shaft 22 and locking arm 23 and a plastic handle 21.

In practice the cargo-locking device is used to secure cargo retaining apparatus such as cross vehicle beams securely to the floor of the vehicle allowing for the secure loading of various cargos within the cargo area.

Although the preferred embodiments of the present invention has been disclosed, various changes and modifications may be made without departing from the scope of the invention as set forth in the appended claims.

1. A cargo retention rail system molded as an integral part of a vehicle floor panel comprising in cooperative combination:
molding at least one cargo retention rail into a vehicle floor panel, said cargo retention rail having a channel with an exposed opening for accepting a cargo retention locking device;
a cargo retention locking device; and
a cargo retaining device mountable to said cargo retention locking device; thereby allowing for cargo to be securely positioned within a vehicle cargo area.

2. The cargo retention rail system as claimed in claim 1 comprising, molding a pair of parallel spaced apart retention rails into said vehicle floor panel.

3. The cargo retention rail system as claimed in claim 1 wherein, said at least one cargo retention rail is composed of extruded aluminum.

4. The cargo retention rail system as claimed in claim 1 wherein, said at least one cargo retention rail is composed of a polymer.

5. The cargo retention rail system as claimed in claim 4 wherein, said polymer is an engineered resin.

6. The cargo retention rail system as claimed in claim 2 wherein, said pair of parallel spaced apart retention rails is positioned with their longitudinal axis in line with the longitudinal axis of the vehicle.

7. The cargo retention rail system as claimed in claim 2 wherein, said pair of parallel spaced apart retention rails is positioned with their longitudinal axis perpendicular to the longitudinal axis of the vehicle.

8. (canceled)
